(19) United States
(12) Patent Application Publication
(10) Pub. No.: US 2009/0090704 A1
(43) Pub. Date: Apr. 9, 2009

(54) PAGER SYSTEM FOR COOKING DEVICE

(76) Inventors: Mark E. Halpin, Burlington, VT (US); Jiri Rabas, Lynnwood, WA (US); David L. Shangraw, Colchester, VT (US); Timothy G. Klauder, Wesley Chapel, FL (US)

Correspondence Address: BRINKS HOFER GILSON & LIONE, P.O. BOX 10395, CHICAGO, IL, 60610, US

(21) Appl. No.: 11/869,459

(22) Filed: Oct. 9, 2007

(51) Int. Cl. G08C 19/00; H05B 1/02

(52) U.S. Cl. 219/209; 340/825.72; 341/176

(57) ABSTRACT

A cooking device having wireless communication capabilities is provided. The cooking device includes a housing forming an enclosure for a food product and a sensor disposed in communication with the enclosure and configured to monitor a parameter within the enclosure, wherein the sensor communicates data that is representative of the parameter. A transmitter communicates with the sensor and is configured to selectively transmit a signal representative of the data. A microprocessor receives the sensor signal from the sensor and communicates with the transmitter and a receiver is configured to receive the signal and provide an indication in response to the signal, wherein the receiver is operable in a remote location from the transmitter.

### BACKGROUND

Ovens for cooking food products disposed therein are known in the art. Ovens typically include a cooking compartment that is configured to receive a food product to be cooked, or baked therein and includes a heat source disposed within, or in communication with the cooking compartment to provide a source of heat to the food product.

Ovens may also include a cooking computer that may include a microprocessor to control the operation of the heat source or other peripheral components disposed therein to apply heat to the food product as desired for proper cooking. The microprocessor may communicate with one or more sensors that are disposed within or in communication with the cooking compartment to provide indications of one or more parameters of interest with respect to the cooking process. The microprocessor continuously monitors the output of the sensors and any information programmed into the microprocessor to control the oven as desired, or as programmed by the user during manufacture.

### SUMMARY

A first representative embodiment of the disclosure provides a cooking device having wireless communication capabilities. The cooking device includes a housing forming an enclosure for a food product, and a heat source disposed within the housing for providing the enclosure with heat. A sensor is disposed in communication with the enclosure and is configured to monitor a parameter within the enclosure, wherein the sensor communicates data that is representative of the parameter. A transmitter is provided in communication with the sensor and configured to selectively transmit a signal representative of the data.

A second representative embodiment of the disclosure provides a method for monitoring a parameter in conjunction with a cooking device. The method includes the steps of heating a food product within an enclosure of an oven, wherein the food product is heated by a heat source disposed within the oven and sensing a parameter within the enclosure. The method additionally includes the steps of providing data to a transmitter representative of the sensed parameter and selectively transmitting a signal remotely from the oven based on the data.

Advantages of the present disclosure will become more apparent to those skilled in the art from the following description of the preferred embodiments of the invention that have been shown and described by way of illustration. As will be realized, the disclosure is capable of other and different embodiments, and its details are capable of modification in various respects. Accordingly, the drawings and description are to be regarded as illustrative in nature and not as restrictive.

### DESCRIPTION OF THE DRAWINGS

FIG. 1 is a perspective view of an oven with a remote monitoring device.

FIG. 2 is a block diagram of the data flow path between the sensor and receiver of the oven of FIG. 1.

FIG. 3 is a block diagram of another possible data flow path between the sensor and receiver of the oven of FIG. 1.

FIG. 4 is a block diagram of a possible data flow path between multiple sensors and a receiver.

FIG. 5 is a block diagram of possible data flow path between multiple sensors and multiple receivers.

FIG. 6 is a block diagram of a possible data flow path between a sensor, a receiver, and a heating member of the oven of FIG. 1.

FIG. 7 is a detail view of the receiver of the oven of FIG. 1.

### DESCRIPTION

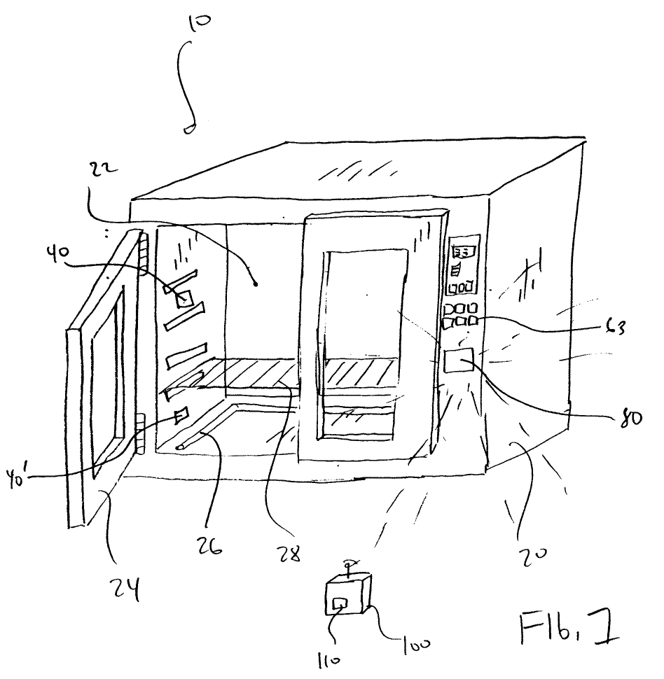

Referring now to the embodiments shown in FIGS. 1-7, a cooking device is provided. The cooking device is described herein as an oven 10, while one of skill in the art will appreciate after reviewing the disclosure that the structure and method disclosed herein is novel to use with other cooking devices such as deep fat fryers, pasta cookers, rethermalizers, refrigerators, microwave ovens, conveyer ovens, and the like, which can be successfully adapted for use with the structure and method disclosed herein. For the sake of brevity, the use with an enclosed oven 10 will be described herein, but one of skill in the art will appreciate how to successfully implement this disclosure in other cooking devices known in the art with an appreciation of the disclosed oven 10.

The oven 10 includes a housing 20 that defines a cooking chamber 22, one or more doors 24 that are openable to allow access to the cooking chamber 22 and closable to selectively isolate the cooking chamber 22, and a heat source 26 disposed within the cooking chamber 22 to apply heat to a food product disposed within the cooking chamber 22. The heat source 26 may be one or more electric resistance heaters, one or more gas combustion heaters, or other types of heat sources suitable for an oven that are known in the art. The housing 20 may additionally include one or more racks 28 or similar structural members to support and align food products within the cooking chamber 22 to receive heat from the heat source 26.

The oven 10 additionally includes one or more sensors 40 disposed proximate to or within the cooking chamber 22. The sensors 40 may be configured monitor a selected parameter related to cooking a food product within the cooking chamber 22 and transmit data that relates to or is proportional to the sensed parameter. By way of example, the sensor 40 may be a temperature sensor that monitors the ambient temperature within the cooking chamber 22, a temperature sensor that monitors a surface or internal temperature of a food product, a moisture or humidity sensor disposed within the cooking chamber 22, or one of a plurality of other types of sensors that are usable with and are related to the process of cooking a food product within an oven 10.

The sensor 40 is configured to communicate data with a microprocessor 60 (discussed below) that is disposed in conjunction with the oven 10. The sensor 40 may provide data by way of a sensor signal X that relates to the parameter being monitored by the sensor 40. In some embodiments, the sensor 40 may provide a sensor signal X that is proportional to a monitored parameter. In other embodiments, the sensor 40 may selectively send the sensor signal X when the monitored parameter is within a predefined range or threshold, or when the monitored parameter is equal to, above, or below a predefined setpoint.

The sensor 40 may be connected to a power source to provide electrical current to provide power to the sensor 40 and to allow the sensor 40 to provide data by way of a sensed signal X that relates to the monitored parameter. The sensor 40 may receive AC or DC current from a microprocessor 60 that the sensor 40 is electrically connected therewith, or the sensor 40 may receive electrical current from a dedicated battery in communication with the sensor 40. The sensor 40 communicates with the microprocessor 60 either with a direct electrical connection or with an indirect connection that enables the sensor 40 to communicate with the microprocessor 60. For example, the sensor 40 may communicate with the microprocessor 60 via a wireless signal, which may be infrared, RF, or other types of signals known in the art.

The microprocessor 60 includes one or more inputs that receive one or more sensed signals X, X′ and data from one or more sensors 40 disposed within, proximate to, or in conjunction with the cooking chamber 22 or the housing 20 of the oven 10. The microprocessor 60 additionally includes a memory that may include RAM, ROM, or a combination of the two, or one or more electromechanical memory devices that enable the microprocessor 60 to receive signals related to the operation of the oven 10 and transmit operational signals to the heat source 26 or other components of the oven 10 to control the operation of the oven 10 as programmed during manufacture of the oven 10 and/or as desired by the user.

The microprocessor 60 additionally includes a transmitter 80 that may receive data, for example a sensed signal X, directly from one or more sensors 40 or alternatively, receive data from the microprocessor 60 that is representative of or related to the data received by the microprocessor 60 from one or more sensors 40. The data may be a sensed signal X. The data received by the transmitter 80 is representative of the parameter sensed by the sensor 40, and may be proportional to the parameter, or otherwise related to the parameter, such as a high or low signal based on the value of the parameter when compared to a reference value stored in the microprocessor. Each of the schematic block diagrams of FIGS. 2-6 show the microprocessor 60 and the transmitter 80 as separate components, but in some embodiments the microprocessor 60 may include the transmitter 80 as a component of the microprocessor 60.

Upon receipt of the data from the microprocessor 60 (or directly from one or more sensors 40 by way of a sensed signal X) the transmitter 80 emits a wireless signal that relates to the data received by the transmitter 80. The wireless signal may be proportional to the data, or otherwise related to the data. By way of example, the wireless signal may be an analog or digital signal that is proportional to the data and ultimately the parameter measured by the sensor 40. Alternatively, the wireless signal may be a high signal when the measured parameter is a predetermined value, above or below a predetermined value, within a range of values, and a low signal (or in some embodiments no signal is transmitted by the transmitter 80) when the parameter measured by the sensor 40 is not the reference value, selectively above or below a reference value, or not within a range of values.

In other embodiments as shown in FIG. 2, the transmitter 80 may emit an address signal Y (discussed below) when the parameter measured by the sensor 40 is equal to a predetermined value, selectively above or below a reference value, or within a predetermined range, as determined by the microprocessor 60 (or transmitter 80), as discussed above instead of emitting the high signal. If the microprocessor 60 determines that the sensed signal X from the sensor 40 satisfies the predetermined value or range (as discussed herein) the microprocessor 60 instructs the transmitter 80 to emit the address signal Y. When the microprocessor 60 determines that the sensed signal X from the sensor 40 does not satisfy the predetermined value or range, the microprocessor 60 does not instruct the transmitter 80 to emit the address signal Y. As discussed below, the receiver 100 may be programmed to alarm, provide a display, or operate upon receipt of one or more specific address signals Y from the transmitter 80.

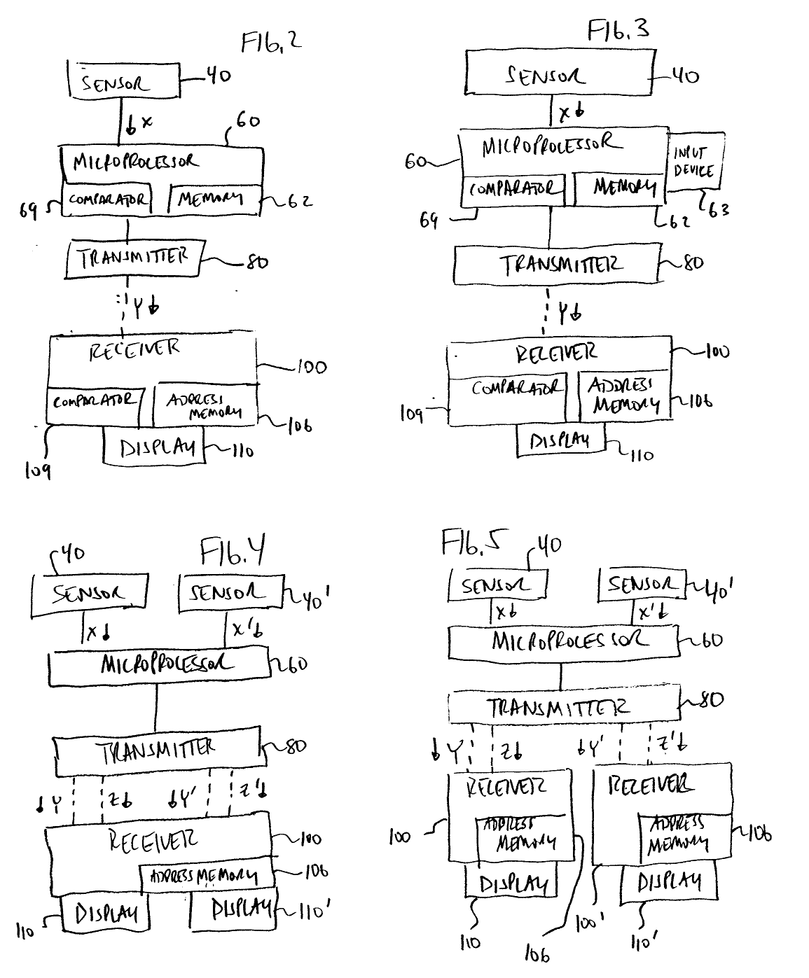

In still further embodiments as shown in FIG. 3, the transmitter 80 may emit an address signal Y, as discussed above, and a data signal Z that is representative of parameter monitored by the sensor 40. The address and data signals Y, Z may be independent signals that are transmitted simultaneously by the transmitter 80, or independent signals that are alternatively transmitted in series. In some embodiments, the address and data signals Y, Z may be related together where one of the address and data signals Y, Z is a carrier signal disposed within or modulated onto the other of the address or data signals Y, Z. In some embodiments, the microprocessor 60 may constantly provide the transmitter 80 with data or the sensed signal X that is representative of the monitored parameter, upon which the data signal Z from the transmitter 80 is generated, which is in turn constantly emitted by the transmitter 80 in addition to the address signal Y. In other embodiments, the microprocessor 60 may selectively transmit data to the transmitter 80.

The wireless signal may be an infrared signal, an RF signal, or another type of wireless signal known in the art. The wireless signal is configured to be received and deciphered by a receiver 100 (discussed below). In some embodiments, the wireless signals (i.e. the address and data signals Y, Z) may operate within any regulated or unregulated band that is configured to allow for reliable communication from the transmitter 80 to the receiver 100 without significant interference with or from other ambient signals that may be sensed by the receiver 100. In some embodiments, the transmitter 80 and the receiver 100 may be configured to operate on an unlicensed Industrial, Scientific, and Medical (ISM) band, such as between 2.4-2.483 GHz.

As shown in FIG. 1, the receiver, or pager 100 is configured to be operable in a remote position with respect to the housing 20 of the oven 10. The receiver 100 is configured to receive a signal from the transmitter 80 and depending on the type and/or magnitude of the signal to selectively provide one or more of a visual, audible, tactile, or vibrational response 104 that is perceptible by a user. The receiver 100 includes an address memory 106 that may be permanently set during manufacture or configuration of the receiver 100, or in other embodiments, the address memory 106 may be adjusted by the user. In some embodiments with adjustable address memory 106, the address memory 106 may include a plurality of binary switches, such as DIP switches, to allow for a discrete number of possible addresses based on the number of DIP switches provided. In some embodiments, four DIP switches may be provided that allow for sixteen discrete address settings. In other embodiments, the address memory 106 may be other types of adjustable storage devices known in the art. For example, the address memory 106 may include RAM or ROM that stores the address of the receiver 100, which would allow for significantly more potential address possibilities than embodiments where the address memory 106 included adjustable binary switches.

The transmitter 80 or the microprocessor 60 includes a memory 62 (shown schematically as a part of the microprocessor 60 in FIG. 2 but also available on the transmitter 80) to store a transmitter code that corresponds to the code stored within the address memory 106 of the receiver 100. In embodiments where the memory 62 is within the microprocessor 60, the microprocessor 60 communicates the transmitter code to the transmitter 80. In embodiments where the transmitter 80 selectively emits an address signal Y, the address signal Y is based on the value of the transmitter code. The memory 62 may be within ROM that is programmed during manufacture or configuration of the oven 10, or in other embodiments, the transmitter code may be configured to be retained within an adjustable memory (such as RAM or an electromechanical device such as a plurality of binary DIP switches) to allow the transmitter 80 to emit various different address signals Y (that are representative of the transmitter code) that are selectively useable by a plurality of different receivers 100. The transmitter code is normally programmed (or otherwise stored within the transmitter 80 or microprocessor 60) to be the same as the code stored in the address memory 106 of the receiver 100. The transmitter or the microprocessor 80, 60 may additionally include an input device 63 that allows the user to provide or modify the transmitter code to be retained with the memory 62.

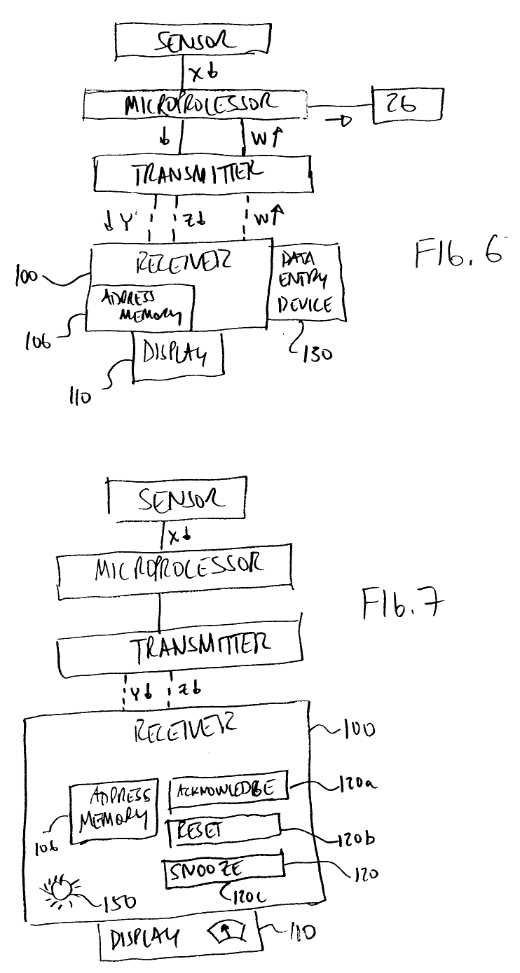

As shown in FIGS. 4-5, the transmitter 80 is configured to emit one or a plurality of signals (i.e. either multiple address signals Y, Y′ and/or multiple data signals Z, Z′ that are representative of sensed signals X, X′ or other data received from multiple sensors 40, 40′ disposed within or proximate the cooking chamber 20) to one or more receivers 100 based upon a plurality of different parameters monitored by one or more sensors 40 within or proximate the cooking compartment 20 of the oven 10. Accordingly, the transmitter 80 may be capable of storing transmitter codes of the various receivers 100 that the transmitter 80 is configured to communicate with. The transmitter 80 may be capable of emitting multiple signals (i.e. multiple address signals Y, Y′ and/or data signals Z, Z′) that are representative of the various parameters monitored by the plurality of sensors 40 and are configured to be interpreted by multiple dedicated receivers 100, 100′ (FIG. 5). Alternatively, a single receiver 100 may be configured to simultaneously monitor for various different address and/or data signals Y, Y′, Z, Z′ and include multiple displays 110, 110′ (FIG. 4), or a single display 110 that provides multiple different indications depending on which parameter is being monitored and displayed by the receiver 100.

In some embodiments, the display 110 of the receiver 100 activates (i.e. provides an indication from the display 110) at any time that a signal (whether address Y or Z) is received from the transmitter 80. In other embodiments, the display 110 only activates when an address signal Y is received by the receiver 100 that corresponds to a receiver code saved by the address memory 106, as discussed below.

The receiver 100 includes a display 110 that provides an indication that is observable by the user. The indication may be visual, audible, tactile, or vibrational and is representative of the value of the parameter sensed by the sensor 40. In some embodiments, the display 110 may have an ON state and an OFF state, which are each selectively provided depending on the receipt of an address signal Y that corresponds to the code stored within the address memory 106. For example, in some embodiments, the display 110 of the receiver 100 is configured to display the ON state when the receiver 100 receives an address signal Y that is representative of the code stored in the address memory 106 of the receiver 100. When the receiver 100 receives other signals, the display 110 remains in the OFF state. The receiver 100 may include a comparator circuit 109 that compares the value of the address signal Y with the code stored in the address memory 106 of the receiver 100.

When the display is in the ON state, the display 110 may emit a light, a noise, a vibration, or other tactile signal. When the display 110 is in the OFF state (i.e. when an address signal Y that corresponds to the code retained in the address memory 106 is not received), the display 110 does not emit a light, noise, vibration or any other discrete signal. As can be understood, the display 110 is in the ON state when the parameter monitored by the sensor 40 is within a specific range, or above or below a specific state as determined by the microprocessor 60.

In some embodiments, the receiver 100 is configured to selectively provide an indication on the display 110 whenever the address signal Y matches the code within the address memory 106 or whenever any address signal Y is received when the address memory 106 is adjusted to a universal code. For example, in some embodiments the address memory 106 may be multiple binary electromechanical switches, such as DIP switches, for example as four DIP switches. In this embodiment, the address memory 106 includes 16 possible codes depending on the position of each of the DIP switches. If the code is adjusted to a predetermined universal code, such as the binary zero value (i.e. all switches to the low position, 0000) the display 110 may be on the ON state whenever any address signal Y is received, which may be useful for testing the communication between the transmitter 80 and the receiver 100. If the code is adjusted to the binary fifteen position (i.e. all switches in the high position, 1111), the display 110 may be on the OFF state regardless of the type or existence of the address signal Y. Further, when code is adjusted to one of the remaining fourteen binary values (i.e. 0001, 0110, etc.) the display 110 is in the ON state whenever the address signal Y corresponds to the code retained within the address memory 106. The receiver 100 may additionally have an ON/OFF switch that selectively allows electrical power flow from the batteries to the display 110 and other circuitry of the receiver 100.

In other embodiments the receiver 100 is configured to selectively display the value of the data signal Z, which may be proportional to the parameter monitored by the sensor 40. In this embodiment, the receiver 100 is configured to receive and process both the address signal Y and the data signal Z (i.e. interpret the address and/or data signals Y, Z and demodulate the signals Y, Z, if necessary). In some embodiments, the receiver 100 constantly receives the address signal Y and compares the address signal Y to the code stored within the address memory 106 with a comparator circuit 109. When the address signal Y matches the code within the address memory 106, the receiver 100 then processes the data signal Z emitted from the transmitter 80. Specifically, the display 110 provides an output that is proportional to the value of the data signal Z, which is ultimately proportional to the value of the parameter measured by the sensor 40 within or proximate the cooking compartment 20. In embodiments where the display 110 provides a visual output, the output may be through a digital or an analog display (i.e. a numerical readout, an analog gauge or meter (FIG. 7) or other types of displays known in the art that provide information related to the value of a parameter), an audible display (that may vary with the magnitude of the data signal Z), or varying tactile or vibrational outputs. The display 110 or the output of the receiver 100 is based on the value of the data signal Z, which is based on the sensed signal X provided by the sensor 40 to the microprocessor 60, and is ultimately based on the value of the parameter monitored by the sensor 40.

In some embodiments as shown in FIG. 7, the receiver 100 may include an acknowledge function and/or a snooze function that are each operable by buttons or other types of operators 120 on the receiver 100. In receivers 100 with acknowledge functions, the display 110 that is on the ON state can be turned off by the user to prevent the display 110 from continuing to alarm. For example, the acknowledge function 120a may be used to prevent a display 110 with an audible alarm from continuing to generate the audible noise. In embodiments with the acknowledge function, the receiver 100 may additionally include a reset 120b that allows the receiver 100 to continue to monitor for an address signal Y corresponding to the code stored in the address memory 106 and provide an indication on the display 110 when appropriate. Receivers 100 with the snooze feature 120c may include an operator 120 that temporarily disables the display 110 from continuing to alarm and allows the alarm function to be restored after a time delay has lapsed. The receiver 100 may additionally include an indication 150, such as a flashing LED, that provides an indication that power is available within the receiver 100 and that the receiver 100 is monitoring for an appropriate address signal Y and/or data signal Z from the transmitter 80.

In some embodiments, the transmitter 80 may initially emit an address signal Y that is representative of the transmitter code when the transmitter 80 is energized. If receiver 100 is also energized and configured to receive the same address signal (i.e. the receiver 100 is not currently in acknowledge mode or snooze mode as discussed above), the receiver 100 display 110 provides an indication that the transmitter 80 and receiver 100 are properly communicating.

In some embodiments, a plurality of sensors 40, 40′ may be disposed within or proximate the cooking compartment 20 and provide data (such as sensed signals X, X′) to the microprocessor 60 that relates to the value of each sensed parameter. The microprocessor 60 includes a plurality of stored reference values and a comparator 69 that compares the data with the reference values to generate a plurality of address signals Y, Y′ and/or the data signals Z, Z′ when the comparator 69 notes a favorable comparison between the sensed signals X, X′ (or other types of data) from the sensor 40, 40′ and the reference values. The microprocessor 60 may assign the data from each specific monitored parameter (by way of sensed signals X, X′) a different address signal Y, Y′, which corresponds to the specific receiver 100, 100′ that is configured to monitor and provide a display related to the sensed parameter.

In still other embodiments shown in FIG. 6, the receiver 100 may be configured to emit an operational signal W and the transmitter 80 is configured to receive the operational signal W and communicate with the microprocessor 60 based on the operational signal W. Further, the receiver 100 may include a data entry device 130, such as a keyboard, one or more input switches, a dial, and the like to allow the user to remotely provide instructions to the microprocessor 60 (by way of an operational signal W received by the transmitter 80) to alter the mode or operations of the heat source 26 or other components of the oven 10, such as an impeller.

In operation, an oven 10 selectively receives a heat input from the heat source 26 disposed within the cooking compartment 20. One or more sensors 40 are disposed within or proximate the cooking compartment 20 and are configured to provide data, such as a sensed signal X, that is representative of the parameter measured by the sensor 40. The one or more sensors 40 communicate with a microprocessor 60 that is provided with the oven 10. The microprocessor 60 includes a comparator 69 that compares the value of the sensed signal X with a reference value or range stored within the memory 62 of the microprocessor 60. The microprocessor 60 communicates with the transmitter 80 depending on the comparison between the sensed signal X and the reference value. In some embodiments, the microprocessor 60 only communicates with the transmitter 80 when the sensed signal X is favorably compared with reference value or range (i.e. the sensed signal X is within a specified range or selectively equal to, above, or below a specified level). In other embodiments, the microprocessor 60 communicates with the transmitter 80 with a signal proportional to the value or state of the parameter monitored by the sensor 40, but also provides a second signal that is based on the output of the comparator circuit 69.

The transmitter 80 receives the output of the microprocessor 60, as discussed above, and selectively emits one or more signals that are representative of the monitored parameter. In a first embodiment, the transmitter 80 emits an address signal Y when the microprocessor 60 sends a signal based upon a favorable comparison with the reference value, and does not emit any signal when a favorable comparison signal is not received. The address signal Y is representative of the transmitter code, which is programmed into one of the microprocessor 60 or the transmitter 80. The transmitter code is the same as the code stored within the address memory 106 of the receiver 100 to ensure proper communication from the transmitter 80 to the receiver 100. The receiver 100 is configured to provide the remote indication related to the monitored parameter based on the receipt of a correct address signal Y. In other embodiments, the transmitter 80 constantly emits an address signal Y (representative of the transmitter code) to the receiver 100 and a data signal Z that is representative of the value of the monitored parameter. In some embodiments the microprocessor 60 may receive sensed signals X, X′ from various different sensors 40, 40′, perform comparison steps with respect to the sensed signals X, X′ from each sensor 40, 40′, and communicate with the transmitter 80 regarding the value of each monitored parameter.

A receiver 100 is provided and is operable in a remote location from the transmitter 80. The receiver 100 is configured to search for an emitted address signal Y that corresponds to the code programmed into the address memory 106 of the receiver 100. In some embodiments, the display 110 of the receiver 100 provides an ON signal (or other type of display discussed herein) whenever the address signal Y corresponding to the code is received by the receiver 100. In other embodiments, the receiver 100 provides an output from the display 110 that is representative of the sensed parameter (based on the value of the data signal Z received by the receiver) whenever an address signal Y received by the receiver 100 matches the code stored in the address memory 106.

It is apparent that apparatus incorporating modifications and variations to the present invention described above will be obvious to one skilled in the art. Inasmuch as the foregoing disclosure is intended to describe the present invention the above description should not be construed to limit the present invention but should be construed to include any obvious variations and should be limited only by the spirit and scope of the following claims. It is therefore intended that the foregoing detailed description be regarded as illustrative rather than limiting, and that it should be understood that it is the following claims, including all equivalents, that are intended to define the spirit and scope of this invention.

What is claimed:

1. A cooking device having wireless communication capabilities, comprising:
a housing forming an enclosure for a food product;
a sensor disposed in communication with the enclosure and configured to monitor a parameter within the enclosure, wherein the sensor communicates data that is representative of the parameter; and
a transmitter in communication with the sensor and configured to selectively transmit a signal representative of the data.

2. The cooking device of claim 1, further comprising a microprocessor that is configured to receive the data from the sensor and communicates with the transmitter.

3. The cooking device of claim 1, further comprising a receiver configured to receive the signal and provide an indication in response to the signal, wherein the receiver is operable in a remote location from the transmitter.

4. The cooking device of claim 3, wherein the receiver is configured to selectively provide a variable indication based on a magnitude of the signal.

5. The cooking device of claim 1, wherein the signal is selectively transmitted based on a magnitude of the data.

6. The cooking device of claim 5, wherein the signal is selectively transmitted based on the magnitude of the data in comparison to a reference value accessible by the transmitter.

7. The cooking device of claim 1, wherein the parameter is selected from one of an atmospheric temperature within the enclosure, a surface temperature of a food product, an internal temperature of a food product, or a length of time from the initiation of a specific event.

8. The cooking device of claim 1, wherein the signal is proportional to the parameter.

9. The cooking device of claim 1, wherein the signal is a digital signal.

10. The cooking device of claim 3, wherein the indication is at least one of a visual, audible, tactile, or a vibrational indication.

11. The cooking device of claim 10, wherein the indication is a visual indication that provides a representation of the value of the parameter.

12. The cooking device of claim 3, wherein the receiver is configured to selectively receive the signal from one of a plurality of different transmitters.

13. The cooking device of claim 1, wherein the transmitter is configured to selectively transmit the signal to a plurality of different receivers.

14. The cooking device of claim 3, wherein the transmitter is configured to store a transmitter code and the receiver is configured to store a receiver code, wherein the signal is representative of the transmitter code and the receiver provides the indication when the signal corresponds to the receiver code.

15. The cooking device of claim 14, wherein the receiver code is adjustable to a universal code, wherein the receiver provides the indication when the receiver receives the signal regardless of the value of the signal when the receiver is adjusted to the universal code.

16. The cooking device of claim 14, wherein the transmitter and receiver codes are each stored in the respective transmitter and receiver with a plurality of binary switches.

17. The cooking device of claim 14, wherein the transmitter is configured to transmit an address signal that is representative of the transmitter code and additionally transfer the signal that is representative of the data.

18. The cooking device of claim 17, wherein the receiver comprises a comparator circuit that is configured to compare the address signal and the receiver code, and the receiver is configured to provide the indication representative of the signal if the address signal corresponds to the receiver code.

19. The cooking device of claim 3, further comprising a second sensor disposed in communication with the enclosure to monitor a second parameter within the enclosure, the transmitter in communication with the second sensor and configured to transmit a second signal representative of the second parameter, and the receiver is configured to receive the second signal and provide a second indication representative of the second signal.

20. The cooking apparatus of claim 1, further comprising a heat source disposed in communication with the enclosure and configured to selectively apply or remove heat from the enclosure.

21. A method for monitoring a parameter within an cooking device, comprising the steps of:
heating a food product within an enclosure of a cooking device, wherein the food product is heated by a heat source disposed within the cooking device;
sensing a parameter within the enclosure;
providing data to a transmitter representative of the sensed parameter; and
selectively transmitting a signal remotely from the oven based on the data.

22. The method of claim 21, further comprising the step of receiving the signal and providing an indication dependent on the value of the signal, wherein the indication is provided by a receiver that is operable in a remote location from the cooking device.

23. The method of claim 21, further comprising the step of comparing the data with a reference value and generating the signal based on the comparison between the data and the reference value.

24. The method of claim 22, further comprising the step of selecting a transmitter code for the transmitter and a receiver code for the receiver, wherein the signal is representative of the transmitter code, and the indication is provided when the signal corresponds to the receiver code.

25. The method of claim 22, further comprising the steps of:
selecting a transmitter code for the transmitter and a receiver code for the receiver;
transmitting an address signal representative of the transmitter code, and the signal proportional to the sensed signal;
receiving the address signal;
comparing the address signal with the receiver code; and
providing the indication of the signal when the address signal corresponds to the receiver code.
